(19) United States
(12) Patent Application Publication
(10) Pub. No.: US 2024/0270236 A1
(43) Pub. Date: Aug. 15, 2024

(54) VEHICLE PARKING ASSIST SYSTEM AND METHOD

(71) Applicant: Ford Global Technologies, LLC, Dearborn, MI (US)

(72) Inventors: Mahmoud Yousef Ghannam, Canton, MI (US); Aed Dudar, Canton, MI (US)

(73) Assignee: Ford Global Technologies, LLC, Dearborn, MI (US)

(21) Appl. No.: 18/167,818

(22) Filed: Feb. 10, 2023

(51) Int. Cl. B60W 30/06

(52) U.S. Cl. CPC B60W 30/06; B60W 2520/28; B60W 2520/30; B60W 2530/201

(57) ABSTRACT

A vehicle parking assist system is disclosed. The vehicle parking assist system may include a transceiver configured to receive parking space information, a memory configured to store vehicle information, and a processor. The processor may be configured to generate a first instruction for a first vehicle wheel and a second instruction for a second vehicle wheel based on the parking space information and the vehicle information. Based on the first instruction and the second instruction, the processor may cause vehicle movement to park a vehicle in a parking space. The processor may be configured to obtain a trigger event, and generate a third instruction for the first vehicle wheel and a fourth instruction for the second vehicle wheel based on the first instruction and the second instruction. Based on the third instruction and the fourth instruction, the processor may cause vehicle movement to exit the vehicle from the parking space.

### FIELD

The present disclosure relates to vehicle parking assist systems and methods and more particularly to vehicle parking systems and methods that provide assistance in parking a vehicle in a garage or a narrow parking space.

### BACKGROUND

Parking a vehicle in a garage (e.g., a home garage) or a narrow/tight parking space may be cumbersome for a vehicle operator. For example, the vehicle operator may face inconvenience in parking the vehicle when the home garage is small or when the vehicle is large (e.g., a truck). The vehicle operator may also face inconvenience when multiple vehicles are required to be parked in the home garage. In addition, parking space structure/layout or artifacts located in the home garage may further increase the challenge in parking the vehicle. In such scenarios, the vehicle operator may be required to make multiple back and forth vehicle movements, steering rotations, maneuvers, etc., to park the vehicle optimally.

Performing such vehicle movements and maneuvers to park the vehicle may be inconvenient and taxing for the vehicle operator. The vehicle operator may face similar inconvenience while exiting the vehicle from the home garage. In some scenarios, such vehicle movements may lead to a vehicle dent as well.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 illustrates a block diagram of an example system for providing vehicle parking assistance, in accordance with the present disclosure.

FIG. 3 illustrates an example embodiment to manage vehicle movement in a parking facility, in accordance with the present disclosure.

FIGS. 4A-4D illustrate example embodiments to manage vehicle(s) in a parking facility, in accordance with the present disclosure.

FIG. 5 illustrates an example embodiment to manage vehicle movement around a corner, in accordance with the present disclosure.

FIG. 6 depicts a flow diagram of an example method for providing vehicle parking assistance, in accordance with the present disclosure.

### DETAILED DESCRIPTION

### Overview

The present disclosure describes a vehicle parking assistance system (“system”) that may be configured to provide assistance to park a vehicle inside a parking facility (e.g., a home garage). The vehicle may be an electric vehicle (EV) having independent wheel drive motor and steering actuator for each vehicle wheel, which may enable each wheel to move independently. The system may be configured to obtain vehicle information and parking facility information, and generate parking instructions for each vehicle wheel based on the obtained information. The parking instructions may be associated with wheel rotation angle, wheel torque, torque polarity, etc. for each vehicle wheel. The system may transmit/display the parking instructions on a vehicle Human-Machine Interface (HMI) or a vehicle infotainment system screen, and the vehicle operator may follow the parking instructions to park the vehicle in the parking facility. Alternatively, the system may transmit the parking instructions to a vehicle control unit that may perform automatic vehicle parking based on the parking instructions. The system may further store the parking instructions in a system memory.

The parking facility information may include parking facility utilization status, parking facility occupancy status, parking facility dimensions, parking facility structure/layout, location and dimension information associated with artifacts/items/products located inside the parking facility, and/or the like. The vehicle information may include vehicle dimensions, vehicle usage behavior and/or historical usage information associated with the vehicle.

In some aspects, the system may generate the parking instructions responsive to receiving a first trigger signal, e.g., when the vehicle is to be parked inside the parking facility. The system may receive the first trigger signal from a user device associated with a vehicle operator, a vehicle Human-Machine Interface (HMI), or via one or more vehicle or parking facility sensors or smart devices (e.g., cameras).

The system may be further configured generate another set of instructions (e.g., exit instructions) for each vehicle wheel when the system receives a second trigger signal. The system may receive the second trigger signal when the vehicle is to be moved out from the parking facility. In some aspects, the exit instructions may be reverse of the parking instructions, and the system may retrieve the parking instructions from the system memory to generate the exit instructions when the system receives the second trigger signal.

The system may transmit/display the exit instructions on the vehicle HMI or the user device, and the vehicle operator may follow the exit instructions to move the vehicle out from the parking facility. Alternatively, the system may transmit the exit instructions to the vehicle control unit, and the vehicle control unit may automatically move the vehicle out from the parking facility based on the exit instructions.

The systems and methods described herein may provide various advantages. For example, the system may be configured to memorize the pattern of moving the vehicle inside the parking facility, which may enable the vehicle to exit the parking facility conveniently. In addition, the system may be configured to effectively manage space inside the parking facility. For example, the system may park the vehicles so that the vehicles and other artifacts located inside the parking facility may be accessed easily. In addition, the system may be configured to easily manage parking of multiple vehicles in the parking facility.

The other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

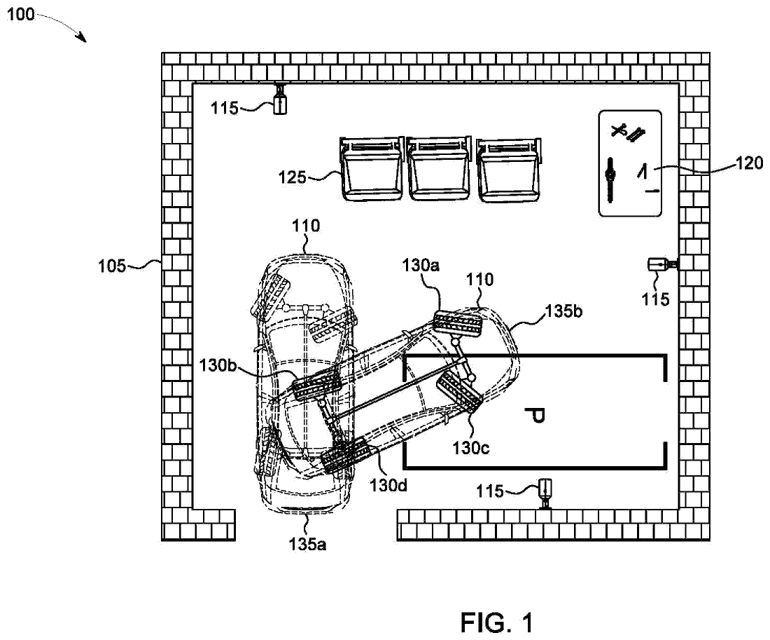

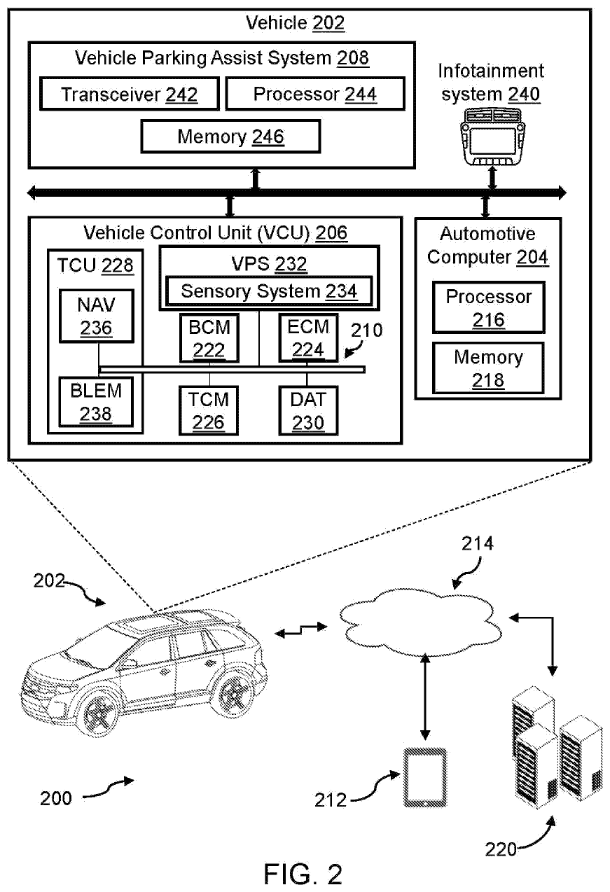

FIG. 1 depicts an example environment 100 in which techniques and structures for providing the systems and methods disclosed herein may be implemented. The environment 100 that may include a parking facility 105 and a vehicle 110. The parking facility 105 may be a home garage (as shown in FIG. 1) or any other similar parking space that may accommodate one or more vehicles. The parking facility 105 may include a parking facility computing device (shown as server 220 in FIG. 2) that may be configured to transmit/receive information, data, instructions, etc. to/from one or more external devices via a network (shown as network 214 in FIG. 2). In some aspects, the parking facility 105 may be connected to the vehicle 110 via the parking facility computing device and the network. The parking facility computing device may be a server or an in-house parking facility computer, laptop, tablet, etc., which a parking facility operator (e.g., a parking facility owner, not shown) may operate.

The parking facility 105 may include one or more smart devices, for example, camera(s) 115, sensors including motion sensors, light sensors, weather sensors (not shown), etc. The smart devices may communicatively couple with the vehicle 110 via the parking facility computing device and the network. For example, the camera(s) 115 may be configured to transmit video feed to the parking facility computing device, which may further transmit the feed to the vehicle 110 via the network. In some aspects, the camera(s) 115 may also directly transmit the feed to the vehicle 110 via the network (without requiring routing the feed via the parking facility computing device). In addition, the parking facility 105 may include items/artifacts such as tools/equipment 120, garbage bins 125, other vehicle(s), etc.

The vehicle 110 may be a Battery Electric Vehicle (BEV). The vehicle 110 may take the form of any passenger or commercial vehicle such as, for example, an off-road vehicle, a car, a crossover vehicle, a van, a minivan, a bus, a truck, etc. Further, the vehicle 110 may be a manually driven vehicle and/or may be configured to operate in partially or fully autonomous mode.

The vehicle 110 may have four wheels including a driver front side wheel 130a, a driver rear side wheel 130b, a passenger front side wheel 130c, and a passenger rear side wheel 130d. The vehicle 110 may be configured to independently control movement of each wheel 130a-130d. In particular, each wheel 130a-130d may have its own independent drive motor and steering actuator that may enable the vehicle 110 to independently control torque, torque polarity, and wheel rotation angle for each wheel 130a-130d. Independent movement control of each wheel 130a-130d may enable a vehicle operator or a vehicle parking assist system (shown as vehicle parking assist system 208 in FIG. 2) to conveniently park the vehicle 110 in the parking facility 105 (e.g., by reducing vehicle turning radius).

In some aspects, the vehicle parking assist system (“system”) may be located in the vehicle 110 (e.g., as part of on-board vehicle computer) and may be configured to provide assistance to the vehicle operator to park the vehicle 110 in the parking facility 105. In particular, the system may obtain parking facility information and vehicle information from the parking facility computing device and/or the vehicle 110, and may generate instructions (e.g., “first instructions”) for each wheel 130a-130d to enable vehicle 110 parking in the parking facility 105 based on the parking facility information and the vehicle information. The system may display the generated instructions on a vehicle Human-Machine Interface (HMI) or a vehicle infotainment system screen, and the vehicle operator may follow the instructions to park the vehicle 110 in the parking facility 105. In further aspects, if the vehicle 110 is a partially or a fully autonomous vehicle, the system may cause the vehicle 110 to move itself and park in the parking facility 105, based on the generated instructions.

In an exemplary aspect, the system may obtain parking facility dimensions/layout and vehicle dimensions, and generate instructions for each wheel 130a-130d according to the obtained dimensions, so that the vehicle 110 may be securely parked in the parking facility 105. For example, if the parking facility 105 is small and/or the vehicle 110 is large, the system may generate instructions to rotate the wheel 130a at an angle of 30 degrees, the wheel 130b at 10 degrees, the wheel 130c at 60 degrees, and the wheel 130d at 0 degrees relative to vehicle longitudinal axis. Rotating the wheels 130a-130d at such angles may cause the vehicle 110 to move/swivel from a vehicle 110 longitudinal position (shown as position 135a) to a vehicle 110 lateral position such that the vehicle 110 may be parked in a parking spot “P”, without requiring much turning space, as shown in FIG. 1. An intermediate position of such vehicle movement is shown as position 135b.

The system may be further configured to “memorize” or store the generated instructions for each wheel 130a-130d in a system memory, and may use the stored instructions to assist the vehicle operator when the vehicle operator exits or moves the vehicle 110 out from the parking facility 105. In particular, the system may retrieve or obtain the stored instructions from the system memory, and generate another set of instructions (e.g., “second instructions”) for the wheels 130a-130d when the vehicle 110 exits the parking facility 105. The system may generate the second instructions based on the stored first instructions (generated when the vehicle 110 entered the parking facility 105). In some aspects, the second instructions may be opposite to or reverse of the stored first instructions. Stated another way, the system may reverse the first instructions and generate the second instructions based on the reversed instructions.

In further aspects, the second instructions may be based on the parking facility information and the vehicle information. For example, if the system determines that the items/artifacts included in the parking facility 105 may have been moved since the vehicle 110 was parked, the system may generate the second instructions based on updated item/artifact location (that may be part of parking facility information). The system may further store the generated second instructions in the system memory.

Similar to the first instructions, the system may display the generated second instructions on the vehicle Human-Machine Interface (HMI) or the vehicle infotainment system screen, and the vehicle operator may follow the second instructions to move the vehicle 110 out from the parking facility 105. Further, if the vehicle 110 is a partially or a fully autonomous vehicle, the system may cause the vehicle 110 to move itself and exit from the parking facility 105, based on the generated second instructions.

FIG. 2 illustrates a block diagram of an example system 200 for providing vehicle parking assistance, in accordance with the present disclosure. The system 200 may include a vehicle 202, which may be same as the vehicle 110. The vehicle 202 may include an automotive computer 204, a Vehicle Control Unit (VCU) 206, and a vehicle parking assist system 208 (same as the vehicle parking assist system described in conjunction with FIG. 1). The VCU 206 may include a plurality of Electronic Control Units (ECUs) 210 disposed in communication with the automotive computer 204.

The system 200 may further include a mobile device 212 that may connect with the automotive computer 204 and/or the vehicle parking assist system 208 by using wired and/or wireless communication protocols and transceivers. In some aspects, the mobile device 212 may be associated with a vehicle user/operator (not shown). The mobile device 212 may communicatively couple with the vehicle 202 via one or more network(s) 214, which may communicate via one or more wireless connection(s), and/or may connect with the vehicle 202 directly by using near field communication (NFC) protocols, Bluetooth® protocols, Wi-Fi, Ultra-Wide Band (UWB), and other possible data connection and sharing techniques.

The network(s) 214 illustrates an example communication infrastructure in which the connected devices discussed in various embodiments of this disclosure may communicate. The network(s) 214 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In some aspects, the automotive computer 204 and/or the vehicle parking assist system 208 may be installed in a vehicle engine compartment (or elsewhere in the vehicle 202), in accordance with the disclosure. Further, the automotive computer 204 may operate as a functional part of the vehicle parking assist system 208. The automotive computer 204 may be or include an electronic vehicle controller, having one or more processor(s) 216 and a memory 218. Moreover, the vehicle parking assist system 208 may be separate from the automotive computer 204 (as shown in FIG. 2) or may be integrated as part of the automotive computer 204.

The processor(s) 216 may be disposed in communication with one or more memory devices disposed in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable memory storing a parking assistance program code. The memory 218 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

In some aspects, the automotive computer 204 and/or the vehicle parking assist system 208 may be disposed in communication with one or more server(s) 220, and the mobile device 212. In some aspects, the server(s) 220 may be part of a cloud-based computing infrastructure and may be associated with and/or include a Telematics Service Delivery Network (SDN) that provides digital data services to the vehicle 202 and other vehicles (not shown in FIG. 2) that may be part of a vehicle fleet. In other aspects, the server 220 may be associated with the parking facility 105 and may be configured to store parking facility information (e.g., parking facility dimensions/layout, locations of artifacts in the parking facility 105, artifacts movement behavior, etc.). In yet another aspect, the server 220 may be a third-party server that may be configured to store vehicle information (such as vehicle usage behavior or historical usage information associated with the vehicle 202). For example, the server 220 may store information associated with vehicle 202 entry/departure times to/from the parking facility 105, occupants (e.g., adults, children, and pets) who generally travel in the vehicle 202, usual parking location in the parking facility 105 where the vehicle 202 may be generally parked, usual vehicle movement pattern in the parking facility 105 from parking facility 105 entry point to the usual parking location, and/or the like.

In accordance with some aspects, the VCU 206 may share a power bus with the automotive computer 204, and may be configured and/or programmed to coordinate the data between vehicle 202 systems, connected servers (e.g., the server(s) 220), and other vehicles (not shown in FIG. 2) operating as part of a vehicle fleet. The VCU 206 can include or communicate with any combination of the ECUs 210, such as, for example, a Body Control Module (BCM) 222, an Engine Control Module (ECM) 224, a Transmission Control Module (TCM) 226, a telematics control unit (TCU) 228, a Driver Assistances Technologies (DAT) controller 230, etc. The VCU 206 may further include and/or communicate with a Vehicle Perception System (VPS) 232, having connectivity with and/or control of one or more vehicle sensory system(s) 234. The vehicle sensory system 234 may include one or more vehicle sensors including, but not limited to, a Radio Detection and Ranging (RADAR or “radar”) sensor configured for detection and localization of objects inside and outside the vehicle 202 using radio waves, sitting area buckle sensors, sitting area sensors, a Light Detecting and Ranging (LiDAR or “lidar”) sensor, door sensors, proximity sensors, temperature sensors, wheel sensors, etc.

In some aspects, the VCU 206 may control vehicle 202 operational aspects and implement one or more instruction sets received from the mobile device 212, from one or more instruction sets stored in computer memory 218 of the automotive computer 204, including instructions operational as part of the vehicle parking assist system 208.

The TCU 228 can be configured and/or programmed to provide vehicle connectivity to wireless computing systems onboard and off board the vehicle 202, and may include a Navigation (NAV) receiver 236 for receiving and processing a GPS signal, a BLE® Module (BLEM) 238, a Wi-Fi transceiver, a UWB transceiver, and/or other wireless transceivers (not shown in FIG. 2) that may be configurable for wireless communication between the vehicle 202 and other systems (e.g., a vehicle key fob, not shown in FIG. 2), computers, and modules. The TCU 228 may be disposed in communication with the ECUs 210 by way of a bus.

In one aspect, the ECUs 210 may control aspects of vehicle operation and communication using inputs from human drivers, inputs from an autonomous vehicle controller, the vehicle parking assist system 208, and/or via wireless signal inputs received via the wireless connection(s) from other connected devices, such as the mobile device 212, the server(s) 220, among others. In some aspects, the ECUs 210 may be configured to control drive motor and steering actuator of each wheel 130a-130d, and thus control independent movement of each wheel 130a-130d based on instructions (e.g., the first instructions and the second instructions described in conjunction with FIG. 1) provided by the vehicle parking assist system 208.

The BCM 222 generally includes integration of sensors, vehicle performance indicators, and variable reactors associated with vehicle systems, and may include processor-based power distribution circuitry that can control functions associated with the vehicle body such as lights, windows, security, camera(s), audio system(s), speakers, door locks and access control, vehicle energy management, and various comfort controls. The BCM 222 may also operate as a gateway for bus and network interfaces to interact with remote ECUs (not shown in FIG. 2).

In some aspects, the DAT controller 230 may provide Level-1 through Level-3 automated driving and driver assistance functionality that can include, for example, active parking assistance, trailer backup assistance, adaptive cruise control, lane keeping, and/or driver status monitoring, among other features. For example, the DAT controller 230 may enable the vehicle parking assist system 208 to automatically (e.g., without vehicle operator involvement) park the vehicle 202 in the parking facility 105 and/or move the vehicle 202 out from the parking facility 105, based on the first and second instructions generated by the vehicle parking assist system 208. The DAT controller 230 may also provide aspects of user and environmental inputs usable for user authentication.

In some aspects, the automotive computer 204 may connect with an infotainment system 240 that may include a touchscreen interface portion, and may include voice recognition features, biometric identification capabilities that can identify users based on facial recognition, voice recognition, fingerprint identification, or other biological identification means. In other aspects, the infotainment system 240 may be further configured to receive user instructions via the touchscreen interface portion, and/or display notifications, navigation maps, etc. on the touchscreen interface portion. For example, the infotainment system 240 may display the first instruction and/or the second instructions provided by the vehicle parking assist system 208, which may assist the vehicle operator to park the vehicle 202 in the parking facility 105 or exit the vehicle 202 from the parking facility 105.

The computing system architecture of the automotive computer 204, the VCU 206, and/or the vehicle parking assist system 208 may omit certain computing modules. It should be readily understood that the computing environment depicted in FIG. 2 is an example of a possible implementation according to the present disclosure, and thus, it should not be considered limiting or exclusive.

In accordance with some aspects, the vehicle parking assist system 208 may be integrated with and/or executed as part of the ECUs 210. The vehicle parking assist system 208, regardless of whether it is integrated with the automotive computer 204 or the ECUs 210, or whether it operates as an independent computing system in the vehicle 202, may include a transceiver 242, a processor 244, and a computer-readable memory 246. The transceiver 242 may be configured to receive information/inputs from external devices or systems, e.g., the mobile device 212, the server 220, the parking facility computing device (described in FIG. 1, if different from the server 220), and/or the like. Further, the transceiver 242 may transmit notifications (e.g., alert/alarm signals, vehicle parking assistance instructions, etc.) to the external devices or systems. In addition, the transceiver 242 may be configured to receive information/inputs from vehicle 202 components such as the infotainment system 240, the vehicle sensory system 234, and/or the like. Further, the transceiver 242 may transmit notifications (e.g., alert/alarm signals, vehicle parking assistance instructions, etc.) to the vehicle 202 components such as the infotainment system 240.

The processor 244 and the memory 246 may be same as or similar to the processor 216 and the memory 218, respectively. Specifically, the processor 244 may utilize the memory 246 to store programs in code and/or to store data for performing aspects in accordance with the disclosure. The memory 246 may be a non-transitory computer-readable memory storing the parking assistance program code.

In some aspects, the processor 244 may be an Artificial Intelligence (AI)-based processor that may use a neural network model (not shown) to execute vehicle parking assist system operation. The neural network model may be stored in the memory 246. The neural network model may be a trained or unsupervised neural network model that may analyze the video feeds from the cameras 115 and/or feeds from the vehicle sensory system 234 (including vehicle camera, radar, lidar, etc.), and may determine movement behavior of artifacts, vehicles, etc. that may be present in the parking facility 105. For example, the neural network may monitor movement of garbage bins 125 in the parking facility 105 (e.g., when a homeowner moves the garbage bins 125 in the parking facility) over time based on feeds from the cameras 115, and determine a trend/pattern of garbage bin movement. In further aspects, the neural network model may monitor vehicle 202 movement in the parking facility 105, and may generate a training model of typical vehicle 202 movement in the parking facility 105. For example, the neural network model may regularly monitor vehicle 202 movement from parking facility 105 entry point to final vehicle parking location in the parking facility 105, and generate the training model based on the monitored movement. In a similar manner, the neural network model may regularly monitor vehicle 202 movement when the vehicle 202 is exited from the parking facility 105, and may generate the training model based on the monitored exit movement. The processor 244 may store the generated training model in the memory 246.

As an example, the neural network may determine that the homeowner moves the garbage bin out from the parking facility 105 every morning between 7-8 AM. In a similar manner, based on the obtained video feeds, the neural network may determine usual parking locations, entry and departure times, usual movement pattern in the parking facility 105, etc. of one or more vehicles that may be generally parked in the parking facility 105, and may accordingly generate (and update) the training model described above.

The processor 244 may determine movement behavior of artifacts, vehicles, etc. at a predefined frequency (e.g., every 1 or 2 minutes) or as and when an artifact or a vehicle is moved, and may store the behavior determined by the neural network in the memory 246, the memory 218, and/or the server 220. In an exemplary aspect, the memory 246, the memory 218, and/or the server 220 may store vehicle movement/usage behavior, as determined by the neural network, as part of vehicle information associated with the vehicle 202. Further, the memory 246, the memory 218, and/or the server 220 may store artifact movement behavior, as determined by the neural network, as part of parking facility information associated with the parking facility 105. In further aspects, the processor 244 may update the stored parking facility information and the vehicle information in the memory 246/server 220 when the processor 244 receives an updated parking facility information and/or vehicle information. For example, the processor 244 may update the parking facility information stored in the memory 246/server 220 when there is a movement of artifact(s) and/or vehicles in the parking facility 105.

In one or more aspects, the neural network model may include electronic data, which may be implemented, for example, as a software component, and may rely on code databases, libraries, scripts, or other logic or instructions for execution of a neural network algorithm by the processor 244. The neural network model may be implemented as code and routines configured to enable a computing device, such as the vehicle parking assist system 208, to perform one or more operations. In some aspects, the neural network model may be implemented using hardware including a processor, a microprocessor, a field-programmable gate array (FPGA), or an application-specific integrated circuit (ASIC). In other aspects, the neural network model may be implemented by using a combination of hardware and software.

Examples of the neural network model may include, but are not limited to, a deep neural network (DNN), a convolutional neural network (CNN), a recurrent neural network (RNN), a CNN-recurrent neural network (CNN-RNN), R-CNN, Fast R-CNN, Faster R-CNN, an artificial neural network (ANN), a Long Short Term Memory (LSTM) network based RNN, CNN+ANN, LSTM+ANN, a gated recurrent unit (GRU)-based RNN, a fully connected neural network, a deep Bayesian neural network, a Generative Adversarial Network (GAN), and/or a combination of such networks. In some aspects, the neural network model may include numerical computation techniques using data flow graphs. In one or more aspects, the neural network model may be based on a hybrid architecture of multiple Deep Neural Networks (DNNs).

In operation, the transceiver 242 may receive a first trigger signal (or a trigger event) when the vehicle 202 enters the parking facility 105 or when the vehicle 202 is in proximity to parking facility 105 entry point. In some aspects, the transceiver 242 may receive the first trigger signal from a vehicle operator, via the mobile device 212 or the infotainment system 240. In other aspects, the transceiver 242 may receive the first trigger signal from a vehicle camera (e.g., exterior vehicle camera), the vehicle sensory system 234, or based on vehicle GPS location (e.g., obtained from the TCU 228). In further aspects, the transceiver 242 may receive the first trigger signal from the server 220 or the parking facility computing device (e.g., when the camera(s) 115 detect vehicle 202 presence in parking facility 105 proximity).

The transceiver 242 may transmit the received first trigger signal to the processor 244. Responsive to obtaining the first trigger signal, the processor 244 may obtain parking facility information associated with the parking facility 105 and vehicle information associated with the vehicle 202 via the transceiver 242. In some aspects, the processor 244 may obtain the parking facility information and the vehicle information from the memory 218, the memory 246, and/or the server 220.

The parking facility information may include parking facility utilization status, parking facility occupancy status, parking facility dimensions (such as length, width, height), parking facility structure/layout (including position of doors, columns, beams, shelves etc. in the parking facility 105), location and dimension information associated with artifacts/items/products (tools/equipment 120, the garbage bins 125, another vehicle(s), other artifacts) located inside the parking facility 105, and/or the like. In some aspects, information associated with artifacts may include artifact location information and artifacts movement behavior (such as times in a day or week when the artifacts may be moved within the parking facility 105 or taken out from the parking facility).

The parking facility information may be updated manually by parking facility 105 operator or may be updated automatically (e.g., by the parking facility computing device, the processor 244, or by the server 220). For example, the parking facility computing device (or the server 220) may determine parking facility 105 utilization/occupancy status using the smart devices (such as the cameras 115) located in the parking facility 105. The parking facility 105 computing device may further update the parking facility utilization status as and when the vehicle 202 enters or exits the parking facility 105. In some aspects, the parking facility 105 computing device may be configured to transmit the parking facility information to the vehicle 202 via the network 214.

The vehicle information may include vehicle dimensions, vehicle usage behavior (including the usual vehicle movement pattern in the parking facility 105), and/or the like. The vehicle usage behavior may include entry/departure times to/from the parking facility 105, occupants (e.g., adults, children, and pets) who generally travel in the vehicle 202, usual vehicle 202 parking location in the parking facility 105, and/or the like. For example, the vehicle usage behavior may include information indicating that the vehicle 202 leaves the parking facility 105 at 7 AM every morning on weekdays, enters the parking facility 105 at 6 PM on weekdays, and stays in the parking facility 105 on weekends. As another example, the vehicle usage behavior may include information indicating that the vehicle 202 is generally parked towards a right side of a parking facility 105 entry door.

In some aspects, responsive to obtaining the parking facility information and the vehicle information, the processor 244 may determine whether the obtained information is sufficient to assist the vehicle operator in parking the vehicle 110 inside the parking facility 105. The processor 244 may determine that the obtained information may not be sufficient, for example, when the vehicle information only includes vehicle dimension information and may not include vehicle usage behavior information. The vehicle information may not include vehicle usage behavior information when, for example, the vehicle operator may be parking the vehicle 202 first time in the parking facility 105 or has parked the vehicle 202 in the parking facility 105 below a threshold count of times. Responsive to determining that the obtained information may not be sufficient, in some aspects, the processor 244 may request (via the mobile device 212 or the infotainment system 240) the vehicle operator to park the vehicle 202 manually so that the processor 244 (specifically, the neural network model) may “learn” vehicle movement pattern/steps and build the training model described above. Responsive to receiving the request from the processor 244, the vehicle operator may manually provide inputs to the vehicle 202 (via steering, push button on dashboard or the infotainment system 240, or the mobile device 212) and park the vehicle 202 inside the parking facility 105. The processor 244 may learn, via the neural network model, the vehicle operator inputs over time, and may store the learning (or the training model) as the vehicle information in the memory 246/server 220 to provide assistance in future.

On the other hand, when the processor 244 determines that the parking facility information and the vehicle information may be sufficient to assist the vehicle operator, the processor 244 may generate instructions (e.g., parking instructions) for each vehicle wheel. The instructions may be based on the obtained parking facility information and the vehicle information. As described above in conjunction with FIG. 1, the instructions may be associated with rotation angle, torque, torque polarity, etc., for each wheel 130a-130d. The instructions may enable the vehicle 202 to move and/or “twist”, “pivot”, “hub” etc., from the parking facility 105 entry point to a final parking location in the parking facility 105. The instructions may assist the vehicle operator to park the vehicle 202 in the parking facility 105, and/or the DAT controller 230 to move the vehicle 202 from the parking facility 105 entry point to the final parking location.

For example, the processor 244 may obtain the parking facility dimension/layout, vehicle dimension, and usual parking spot location (at which the vehicle 202 may be parked), and may generate a first instruction for the driver front side wheel 130a, a second instruction for the driver rear side wheel 130b, a third instruction for the passenger front side wheel 130c, and a fourth instruction for the passenger rear side wheel 130d based on the obtained information. The first instruction, the second instruction, the third instruction, and the fourth instruction (collectively referred to as parking instruction) may be same or different from each other. In particular, the processor 244 may generate the instructions to move the vehicle 202 from the parking facility 105 entry point to the parking spot location (e.g., the parking spot “P” as shown in FIG. 1).

The processor 244 may be configured to cause a vehicle first movement based on the first instruction, the second instruction, the third instruction, and the fourth instruction to park the vehicle 202 in the parking facility 105. In some aspects, the processor 244 may transmit the generated parking instructions to the VCU 206. The VCU 206 (specifically the ECUs 210) may receive the parking instructions and may control vehicle 202 movement based on the instructions. For example, the VCU 206 may control individual drive motors and steering actuators of wheels 130a-130d to park the vehicle 202 in the parking facility 105. In other aspects, the processor 244 may display the parking instructions on the infotainment system 240 or the mobile device 212, and the vehicle operator may follow the displayed instructions to park the vehicle 202.

The processor 244 may be further configured to store the generated parking instructions (e.g., the first instruction, the second instruction, the third instruction, and the fourth instruction) in the memory 246. The processor 244 may be configured to retrieve or obtain the parking instructions from the memory 246, and generate another set of instructions (e.g., exit instructions) for each wheel when the vehicle 202 exits the parking facility 105.

In particular, the processor 244 may generate the exit instructions when the processor 244 obtains a second trigger signal (e.g., a second trigger event) via the transceiver 242. The processor 244 may obtain the second trigger signal when the vehicle 202 is to be moved out from the parking facility 105. The processor 244 may obtain the second trigger signal from the vehicle operator or automatically from the mobile device 212, the infotainment system 240, vehicle camera(s), the vehicle sensory system 234, the TCU 228, the server 220, or the parking facility 105 computing device, similar to obtaining the first trigger signal. The processor 244 may generate the exit instructions responsive to receiving the second trigger signal. The exit instructions may assist the vehicle operator to move the vehicle 202 out from the parking facility 105. The processor 244 may generate the exit instructions based on the parking instructions generated when the vehicle 202 entered the parking facility 105. The exit instructions for exiting the parking facility 105 may be reverse of the parking instructions for entering the parking facility 105.

As part of the exit instructions, the processor 244 may generate a fifth instruction for the wheel 130a, a sixth instruction for the wheel 130b, a seventh instruction for the wheel 130c, an eight instruction for the wheel 130d based on the parking instructions (i.e., the corresponding first instruction, the second instruction, the third instruction, and the fourth instruction). In some aspects, the fifth instruction may correspond to (e.g., be reverse of) the first instruction, the sixth instruction may correspond to the second instruction, the seventh instruction may correspond to the third instruction, and the eight instruction may correspond to the fourth instruction.

Responsive to generating the exit instructions, the processor 244 may cause a vehicle movement (e.g., a vehicle second movement) to move the vehicle 202 out from the parking facility 105 based on the exit instructions. In particular, the processor 244 may transmit the generated exit instructions to the VCU 206. The VCU 206 (specifically the ECUs 210) may obtain the exit instructions and enable the vehicle 202 to move out from the parking facility 105. In further aspects, the processor 244 may display the exit instructions on the infotainment system 240 or the mobile device 212, and the vehicle operator may follow the exit instructions to move the vehicle 202 out from the parking facility 105. In further aspects, the processor 244 may store the exit instructions in the memory 246.

In additional aspects of the present disclosure, the processor 244 may be further configured to generate instructions to prevent motion of the parking facility 105 entry door when the vehicle 202 may be moving in the parking facility 105. The processor 244 may transmit the generated instructions to the server 220, and the server 220 may control/prevent parking facility entry door movement based on the instructions. In some aspects, the processor 244 may transmit the instructions described here when the processor 244 transmits the parking instruction and/or the exit instruction.

Parking facility 105 entry door movement when the vehicle 202 may be moving may introduce noise factors (and may interfere with vehicle sensory system 234) such as glare from sun, weather conditions (such as rain/snow), interference of pets/animals, etc. Therefore, the processor 244 prevents the parking facility 105 entry door movement to minimize noise factors.

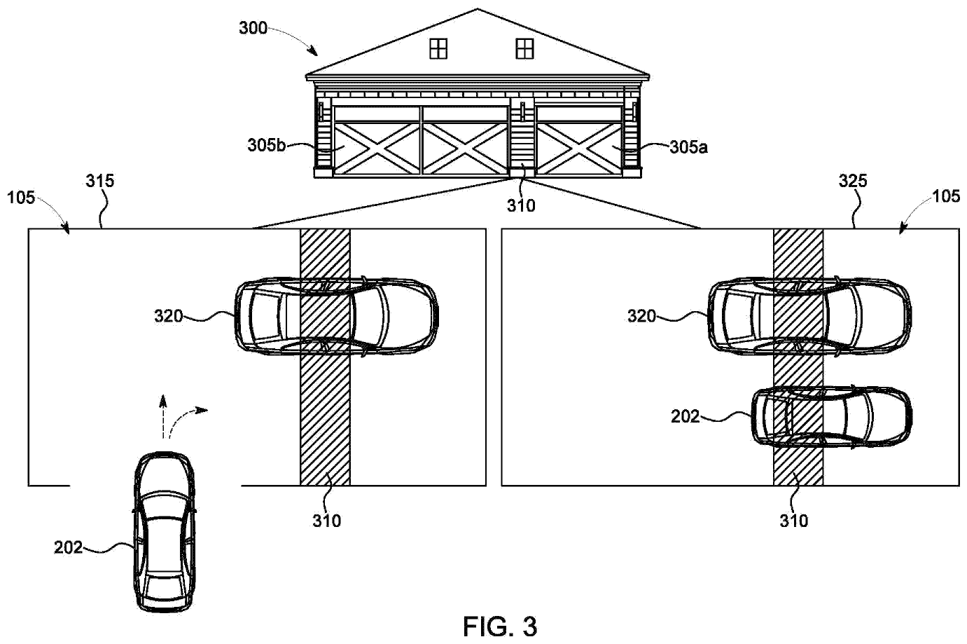

FIG. 3 illustrates an example embodiment to manage vehicle movement in the parking facility 105, in accordance with the present disclosure. In particular, FIG. 3 illustrates a home 300 having the parking facility 105 (or a home garage). The parking facility 105 may be a single door garage, a double door garage, a triple door garage, or a combination thereof. An exemplary structure is shown in FIG. 3, in which the parking facility 105 includes a single door garage 305aand a double door garage 305b. In some aspects, the size of the double door garage 305b may be double the size of the single door garage 305a. In further aspects, the single door garage 305a and the double door garage 305b may be of any shape and size.

In some aspects, the home 300 may further include external structure(s) 310. The external structure(s) 310 may be a beam, a pillar or a concrete structure, which may connect the single door garage 305a and the double door garage 305b. The external structure(s) 310 may be a wall portion between the single door garage 305a and the double door garage 305b. The parking facility 105 information (described in conjunction with FIG. 2) may include information associated with the external structure(s) 310.

In some aspects, a vehicle (e.g., the vehicle 202) may enter the parking facility 105 from the single door garage 305a or the double door garage 305b, and may be parked straight or longitudinally along an entry path (e.g., a straight position 135a). In other aspects, the vehicle 202 may enter the parking facility 105 and may be parked laterally/sideways (perpendicular to the straight position, e.g., in the parking spot “P” as shown in FIG. 1), or any other position. As discussed above, the vehicle information may include information associated with usual vehicle parking location in the parking facility 105 where the vehicle 202 may be generally parked, and usual vehicle movement pattern in the parking facility 105 from the parking facility 105 entry point to the usual parking location.

In an exemplary aspect, when the vehicle 202 enters the parking facility 105 (as shown in view 315), the processor 244 may identify the parking spot based on the parking facility information and the vehicle information. In some aspects, the processor 244 may identify the parking spot based on the usual parking location. In other aspects, the processor 244 may analyze parking facility dimensions and artifacts (such as a vehicle 320 already parked, garbage bins 125) located in the parking facility 105. The processor 244 may be configured to identify a parking spot such that the vehicle 202 may maintain a preset distance from the vehicle 320, parking facility walls (or other artifacts) and the garbage bins 125. This may enable the vehicle operator to easily access the vehicle 202 and other artifacts/vehicle 320 in the parking facility 105.

The processor 244 may be further configured to identify the parking spot based on dimension and usage information of the vehicles 202, 320. For example, vehicle 202, 320 dimension information may indicate that the vehicle 202 is a small-sized vehicle and the vehicle 320 is a large-sized vehicle. Further, vehicle 202, 320 usage information may indicate that the vehicle 202 is usually parked between 8 PM to 7 AM on weekdays and stays in the parking facility 105 over weekends, and the vehicle 320 is occasionally used. The processor 244 may use this example dimension and usage information to identify the parking spot for the vehicle 202, as described below.

Since the vehicle 320 may be large-sized and occasionally used, a vehicle 320 processor (not shown) may generate parking instructions to park the vehicle 320 laterally and behind the external structure 310 to utilize the parking facility 105 width optimally (as shown in the view 315). For the vehicle 202, the processor 244 may generate parking instructions to park the vehicle 202 in the straight position (or longitudinally, e.g., at the position 135a shown in FIG. 1) on weekdays, so that the vehicle operator may easily park and exit the vehicle 202 to/from the parking facility 105. On weekends, the processor 244 may generate parking instructions to park the vehicle 202 laterally (e.g., at the parking spot “P” as shown in FIG. 1, or also shown as view 325 in FIG. 3) so that the vehicle operator may utilize unused space in the parking facility 105 on the weekends (e.g., for moving the garbage bins 125 in and out on Sundays, or for other activities).

In further aspects, the processor 244 may identify the parking spot based on count of occupants present inside the vehicle 202 during parking. The processor 244 may obtain information associated with the occupants in real-time (e.g., via the vehicle sensory system 234) or from the vehicle usage information (stored in the memory 246). For example, when the vehicle 202 only has driver in the vehicle 202, the processor 244 may identify a parking spot that provides more gap in the driver side so that the driver may conveniently leave and access the vehicle 202. Further, in this case, the identified parking spot may have less space on the opposite side to optimize parking facility space. On the other hand, when the vehicle 202 has driver and a front passenger, the processor 244 may identify a parking spot that may provide space for the driver and the passenger to conveniently leave and access the vehicle 202.

Responsive to identifying the parking spot, the processor 244 may generate parking instructions for each vehicle wheel and cause a vehicle movement (including swiveling, sliding, pivoting etc.) to park the vehicle 202 at the identified parking spot. The processor 244 may store the parking instructions in the memory 246, as described above.

As described above, the processor 244 may further assist the vehicle 202 in leaving the parking facility 105. The processor 244 may use the stored parking instructions to generate exit instructions for each vehicle wheel to leave the vehicle 202 from the parking facility 105. In particular, the processor 244 may generate the exit instructions such that the vehicle 202 may follow the same or similar path to leave the parking facility 105, which was used to park the vehicle 202 in the parking facility 105. The processor 244 may further cause a vehicle movement to enable the vehicle 202 exit the parking facility 105.

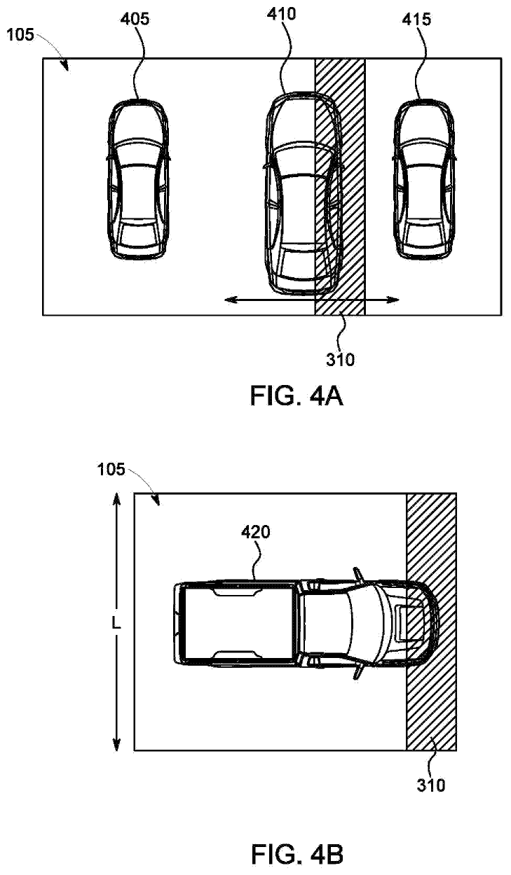

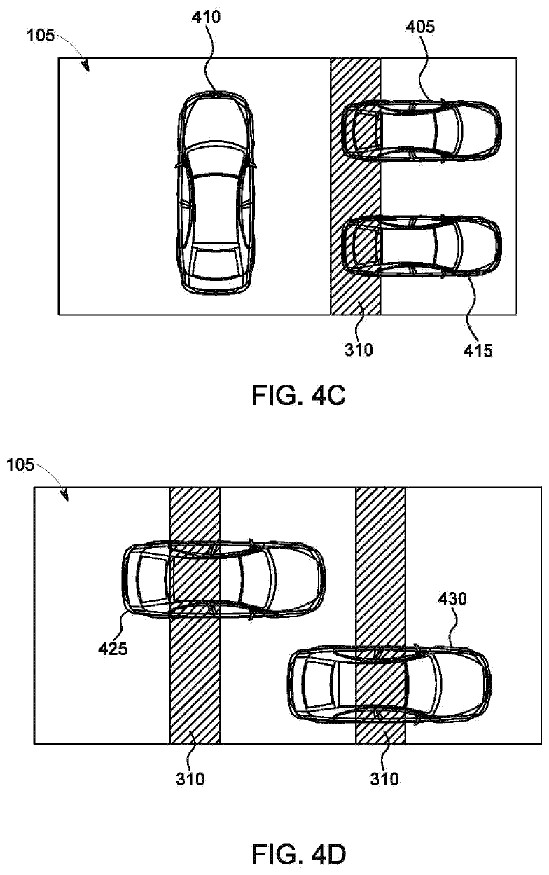

FIGS. 4A-4D illustrate example embodiments to manage vehicle(s) in the parking facility 105, in accordance with the present disclosure. FIG. 4A illustrates a first embodiment in which respective processors of vehicles 405, 410, and 415 may manage vehicle parking in the parking facility 105. The vehicle 410 (which may be same as the vehicle 202) may be a large-sized vehicle and may be rarely used (or may have late departure time). The vehicles 405 and 415 may be medium-sized vehicles, and the vehicle 405 may be most often used, followed by the vehicle 415.

The processor 244 may obtain vehicle information associated with the vehicles 405, 410, 415 and the parking facility 105 information from the memory 246 or the server 220 (and/or from the vehicle operator). Responsive to obtaining the information, the processor 244 may determine an optimal parking arrangement to park the vehicle 410 in the parking facility 105 and to exit the parking facility 105 based on the obtained information (as described above).

Based on the determined optimal parking arrangement, the processor 244 may generate parking instructions, and transmit the parking instructions to the vehicle operator via the mobile device 212 or the infotainment system 240, or may cause automatic vehicle 410 movement via respective DAT controller 230. For example, the processor 244 may generate parking instructions to cause the vehicle 410 to enter the parking facility 105 from the single door garage 305a or the double door garage 305b, and then activate sideways vehicle movement to move the vehicle 410 to a parking facility 105 area that may be behind the external structure 310 (which may allow the vehicle 410 to utilize space that may not be usually used). Such parking instructions may be stored in the memory 246.

In a similar manner, the vehicles 405 and 415 may be parked (via respective vehicle processors and/or the vehicle operator) in their respective parking locations in the parking facility 105, as shown in FIG. 4A. When the vehicle operator moves the vehicle 405 out from the parking facility 105, the processor 244 may sense vehicle 405 departure (e.g., via inputs obtained from the vehicle sensory system 234 and/or vehicle 410 cameras). Responsive to sensing the vehicle 405 departure, the processor 244 may generate instructions to activate the sideways vehicle 410 movement to provide easy access for the vehicle operator to the vehicle 415. Stated another way, the processor 244 may activate the sideways vehicle 410 movement to expand a “gap” between the vehicle 410 and the vehicle 415, thus enabling easily access to vehicle 415 doors. In this manner, the large-sized vehicle 410 may automatically move inside the parking facility 105 in left or right direction to allow all vehicles (e.g., vehicles 405, 410, 415) to be conveniently and tightly packed in the parking facility 105, and at the same time to allow easy access to all vehicles.

In some aspects, the processor 244 may manage vehicle 410 parking in the parking facility 105 based on weather or environment conditions, as determined from environment information obtained from the vehicle sensory system 234. For example, if the processor 244 determines that it may rain soon, the processor 244 may manage vehicle 410 parking inside the parking facility 105 such that there is enough rooms for other vehicles (e.g., the vehicles 405 and 415) to get accommodated in the parking facility 105.

FIG. 4B describes a second embodiment to manage a vehicle 420 (which may be same as the vehicle 202) in the parking facility 105. The vehicle 420 may be a large-sized vehicle (such as an extended chassis SUV or truck) having a length that may be longer than a length “L” of the parking facility 105. Stated another way, it may be difficult to park the vehicle 420 longitudinally or lengthwise in the parking facility 105. In such scenarios, the processor 244 may generate parking instructions to perform vehicle “swiveling” maneuver to park the vehicle 420 laterally (as shown in FIG. 4B), and as discussed in conjunction with FIG. 1. In this case, the vehicle 420 may utilize the space that may be behind the external structure 310. As discussed above, the vehicle operator may manually park the vehicle 420 based on the generated parking instructions or the vehicle 420 may automatically park itself based on the generated instructions via the DAT controller 230. The generated parking instructions may be stored in the memory 246, and may be retrieved when the vehicle 420 moves out from the parking facility 105. In particular, the processor 244 may reverse the swivel steps to move the vehicle 420 out from the parking facility 105.

FIG. 4C illustrates a third embodiment to manage the vehicles 405, 410 and 415 in the parking facility 105. In this case, the processor 244 may generate the parking instructions to park the vehicle 410 in a straight position (or longitudinally, e.g., at the position 135a shown in FIG. 1), and the vehicles 405 and 415 may be parked laterally.

FIG. 4D illustrates a fourth embodiment to manage vehicles 425 and 430 in the parking facility 105. In this case, both the vehicles 425, 430 may be large-sized vehicles, and respective processors of the vehicles 425, 430 may generate parking instructions to park both the vehicles 425, 430 laterally. The vehicle 425 may be parked at parking facility left side and the vehicle 430 may be at parking facility right side, to provide enough space to open respective vehicle doors easily.

A person ordinarily skilled in the art may appreciate that in the manner described above, the processor 244 may optimize the parking facility space based on required conditions, which may vary from vehicle to vehicle. The processor 244 may further utilize “dead space” on sides of the parking facility 105 to provide gaps between multiple vehicles.

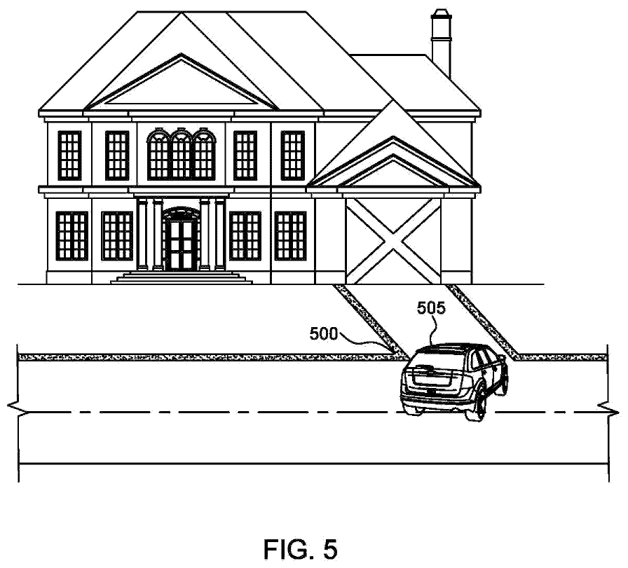

FIG. 5 illustrates an example embodiment to manage vehicle movement around a corner 500 (e.g., a tight space), in accordance with the present disclosure. Due to different landscaping and road plans, one side of driveway (e.g., the corner 500) may have a sharp entry angle, which may make it difficult for the vehicle operator to move a vehicle (e.g., a vehicle 505, same as the vehicle 202) around the corner 500. In such scenarios, the processor 244 may obtain the vehicle information and narrow space information (which may be part of parking facility information) from the memory 246/server 220. Based on the vehicle information and the narrow space information, the processor 244 may generate parking or movement instructions to control each vehicle wheel so that the vehicle 505 may move around the corner 500 easily. The processor 244 may further store the generated instructions in the memory 246 so that the vehicle 505 may perform auto-driveway entry mode in the future.

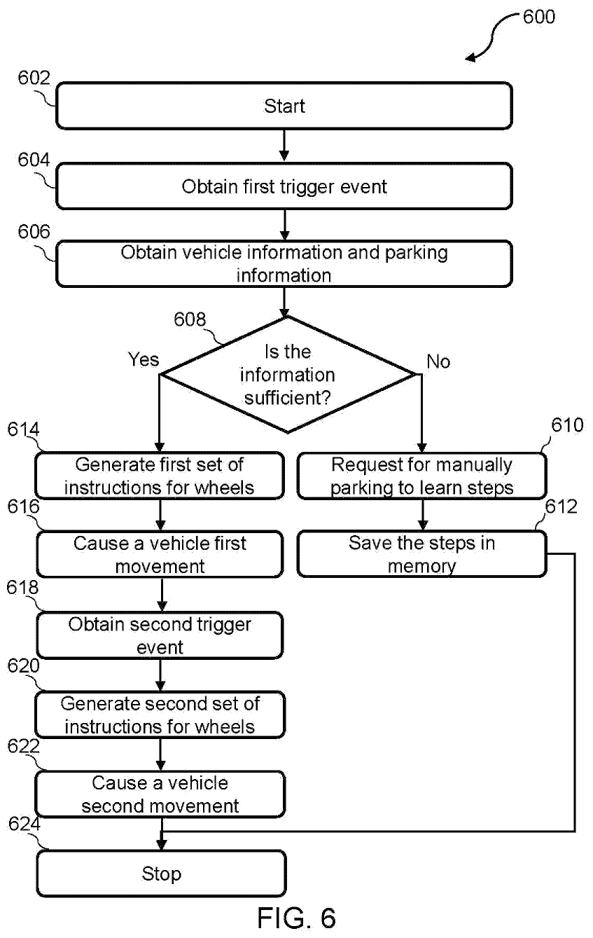

FIG. 6 depicts a flow diagram of an example method 600 for providing vehicle parking assistance, in accordance with the present disclosure. FIG. 6 may be described with continued reference to prior figures, including FIGS. 1-5. The following process is exemplary and not confined to the steps described hereafter. Moreover, alternative embodiments may include more or less steps that are shown or described herein and may include these steps in a different order than the order described in the following example embodiments.

Referring to FIG. 6, at step 602, the method 600 may commence. At step 604, the method 600 may include obtaining, by the processor 244, a first trigger event. In particular, the processor 244 may obtain the first trigger event when the vehicle 202 enters the parking facility 105 or when the vehicle 202 is in proximity to the parking facility 105 entry point. The processor 244 may obtain the first trigger event from the mobile device 212, the infotainment system 240, the vehicle sensory system 234, vehicle cameras, the TCU 228, the server 220, or the parking facility 105 computing device.

At step 606, the method 600 may include obtaining, by the processor 244, the vehicle information and the parking facility information. The processor 244 may obtain the vehicle information and the parking facility information from the memory 246 and/or the server 220.

At step 608, the method 600 may include determining, by the processor 244, whether the vehicle information and the parking facility information are sufficient to generate parking instructions to park the vehicle 202 in the parking facility 105. In particular, the processor 244 may determine whether a trained model is available (e.g., in the memory 246) that the processor 244 may use to park (or exit) the vehicle 202 in the parking facility 105.

Responsive to a determination that the information may be insufficient, the method 600 moves to step 610. At step 610, the method 600 may include transmitting, by the processor 244, a request to a vehicle operator to perform parking manually, and the processor 244 may learn the steps that may be performed by the vehicle operator to park the vehicle 202. At step 612, the method 600 may include saving, by the processor 244, the steps in the memory 246. In particular, the processor 244 may store the steps in the memory 246 so that the processor 244 may use the stored steps to provide assistance in future to the vehicle operator to park the vehicle 202 in the parking facility 105. The method 600 then moves to step 624, at which the method 600 may stop.

Responsive to a determination that the information is sufficient at the step 608, the method 600 moves to step 614. At step 614, the method 600 may include generating, by the processor 244, a first set of instructions for vehicle wheels. In particular, the processor 244 may generate instructions for each vehicle wheel based on the vehicle information and the parking facility information. At step 616, the method 600 may include causing, by the processor 244, a vehicle first movement based on the first set of instructions. In particular, the processor 244 may transmit/display the generated instructions to mobile device 212 or the infotainment system 240 so that the vehicle operator may use the instruction to park the vehicle 202 in the parking facility 105. Alternatively, the processor 244 may transmit the instructions to the VCU 206, and the VCU 206 may automatically move the vehicle 202 based on the generated instructions.

At step 618, the method 600 may include obtaining, by the processor 244, a second trigger event. In particular, the processor 244 may obtain the second trigger event when the vehicle 202 is to be moved out from the parking facility 105. At step 620, the method 600 may include generating, by the processor 244, a second set of instructions. In particular, the processor 244 may generate the second set of instructions for each wheel based on the first set of instructions to move the vehicle 202 out from the parking facility 105. At step 622, the method 600 may include causing, by the processor 244, a vehicle second movement based on the second set of instructions. In particular, the processor 244 may transmit/display the generated instructions to the mobile device 212 or the infotainment system 240 so that the vehicle operator may use the instructions to move the vehicle 202 out from the parking facility 105. Alternatively, the processor 244 may transmit the instructions to the VCU 206, and the VCU 206 may move the vehicle 202 based on the generated instructions.

The method 600 may end at step 624.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer- readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle parking assist system comprising:
a transceiver configured to receive parking space information;
a memory configured to store vehicle information; and
a processor communicatively coupled to the transceiver and the memory, wherein the processor is configured to:
generate, based on the parking space information and the vehicle information, a first instruction for a first vehicle wheel and a second instruction for a second vehicle wheel;
cause, based on the first instruction and the second instruction, a vehicle first movement to park a vehicle in a parking space;
obtain a first trigger event;
generate, responsive to obtaining the first trigger event and based on the first instruction and the second instruction, a third instruction for the first vehicle wheel and a fourth instruction for the second vehicle wheel; and
cause, based on the third instruction and the fourth instruction, a vehicle second movement to exit the vehicle from the parking space.

2. The vehicle parking assist system of claim 1, wherein the memory is further configured to store the first instruction, the second instruction, the third instruction, and the fourth instruction.

3. The vehicle parking assist system of claim 2, wherein the processor is further configured to:
retrieve the first instruction and the second instruction from the memory;
reverse the first instruction and the second instruction responsive to retrieving; and
generate the third instruction and the fourth instruction based on reversed instructions.

4. The vehicle parking assist system of claim 1, wherein the parking space information comprises parking space availability and parking space structure information.

5. The vehicle parking assist system of claim 4, wherein the parking space information further comprises artifact location information and artifact movement information associated with artifacts present in the parking space.

6. The vehicle parking assist system of claim 1, wherein the vehicle information comprises vehicle dimensions and vehicle usage behavior.

7. The vehicle parking assist system of claim 1, wherein the processor is further configured to:
obtain a second trigger event; and
generate the first instruction and the second instruction responsive to obtaining the second trigger event.

8. The vehicle parking assist system of claim 1, wherein the processor is further configured to generate the third instruction and the fourth instruction based on the parking space information and the vehicle information.

9. The vehicle parking assist system of claim 1, wherein the processor is further configured to:
generate a training model for each vehicle wheel based on the first instruction and the second instruction; and
generate the third instruction and the fourth instruction based on the training model.

10. The vehicle parking assist system of claim 1, wherein the vehicle parking assist system is located inside the vehicle.

11. The vehicle parking assist system of claim 1, wherein the first instruction, the second instruction, the third instruction, and the fourth instruction comprise instructions associated with wheel rotation angle, wheel torque, and wheel speed.

12. A method to provide vehicle parking assistance comprising:
generating, by a processor, a first instruction for a first vehicle wheel and a second instruction for a second vehicle wheel based on parking space information and vehicle information;
causing, by the processor, a vehicle first movement based on the first instruction and the second instruction to park a vehicle in a parking space;
obtaining, by the processor, a first trigger event;
responsive to obtaining the first trigger event, generating, by the processor, a third instruction for the first vehicle wheel and a fourth instruction for the second vehicle wheel based on the first instruction and the second instruction; and
causing, by the processor, a vehicle second movement based on the third instruction and the fourth instruction to exit the vehicle from the parking space.

13. The method of claim 12, further comprising storing the first instruction, the second instruction, the third instruction, and the fourth instruction in a memory.

14. The method of claim 13 further comprising:
retrieving the first instruction and the second instruction from the memory;
reversing the first instruction and the second instruction responsive to retrieving; and
generating the third instruction and the fourth instruction based on reversed instructions.

15. The method of claim 12, wherein the parking space information comprises parking space availability and parking space structure information.

16. The method of claim 15, wherein the parking space information further comprises artifact location information and artifact movement information associated with artifacts present in the parking space.

17. The method of claim 12, wherein the vehicle information comprises vehicle dimensions and vehicle usage behavior.

18. The method of claim 12 further comprising:
obtaining a second trigger event; and
generating the first instruction and the second instruction responsive to obtaining the second trigger event.

19. The method of claim 12, wherein the first instruction, the second instruction, the third instruction, and the fourth instruction comprise instructions associated with wheel rotation angle, wheel torque, and wheel speed.

20. A non-transitory computer-readable storage medium having instructions stored thereupon which, when executed by a processor, cause the processor to:
generate a first instruction for a first vehicle wheel and a second instruction for a second vehicle wheel based on parking space information and vehicle information;
cause a vehicle first movement based on the first instruction and the second instruction to park a vehicle in a parking space;
obtain a trigger event;
responsive to obtaining the trigger event, generate a third instruction for the first vehicle wheel and a fourth instruction for the second vehicle wheel based on the first instruction and the second instruction; and
cause a vehicle second movement based on the third instruction and the fourth instruction to exit the vehicle from the parking space.
